(19) United States
(12) Patent Application Publication
(10) Pub. No.: US 2002/0087741 A1
(43) Pub. Date: Jul. 4, 2002

(54) Plugable call control application program interface

(76) Inventors: Stephen S. Ing, Beaverton, OR (US); Hani El-Gebaly, Beaverton, OR (US); Mike J. Gutmann, Hillsboro, OR (US); Kalon R. Kelley, Santa Barbara, CA (US)

Correspondence Address: Pillsbury Madison & Sutro LLP, Intellectual Property Group, Ninth Floor, East Tower, 1100 New York Avenue, N.W., Washington, DC, 20005-3918, US

(21) Appl. No.: 09/750,532

(22) Filed: Dec. 28, 2000

(51) Int. Cl. G06F 9/46; G06F 9/00

(52) U.S. Cl. 709/328

(57) ABSTRACT

A plugable call control application program interface includes a base plugable call control application program interface to expose a common set of function calls, properties, and callbacks to be utilized by a plurality of call control protocols. An extended application program interface is adapted to provide advanced function calls, properties, and callbacks beyond the common set.

### BACKGROUND OF THE INVENTION

1. Field of the Invention

The present invention relates to an application program interface (API), and more specifically, to a plugable call control API that allows a single client application to place calls through multiple protocols utilizing a single API, via for example, Internet Protocol (IP) telephony.

2. Discussion of the Related Art

Internet telephony allows people to use the Internet as the transmission medium for telephone calls. For callers who have Internet access, Internet telephony provides an ability to make “free” telephone calls. The basic steps involved in originating an Internet telephone call are conversion of the analog voice signal to digital format, and compression/translation of the signal into, for example, Internet Protocol (IP) packets for transmission over the Internet, with the process being reversed at the receiving end. Therefore, users can bypass long-distance carriers (and the associated per-minute usage rates) and run their voice traffic over the Internet. By utilizing Internet telephony, such as Voice over IP (VoIP), a company, for example, could cut intracompany phone/fax communication costs by avoiding long distance charges.

Additionally, by utilizing IP telephony, costs may be further reduced because voice and data traffic may be carried over a single network, rather than one for voice (telephone) applications, and another for data (computer) applications. Therefore, instead of paying for and maintaining two separate networks, a single network may be utilized for both voice and data traffic. As a result of the growing popularity of IP telephony, several call control protocols have become available. A call control application program interface (API) is a custom interface that is typically tailored to a particular protocol's features and characteristics. APIs are interfaces (routines, protocols, and tools) between a software layer and application programs, which may determine how the application programs communicate with the operating system, and the services the operating system makes available to the programs. However, a specific client application written for a particular call control API is not readily compatible with other call control protocols and their respective APIs.

Call control protocol APIs are complicated, each having numerous function calls, properties, and callbacks (with the data provided thereto), many of which are not utilized most of the time. However, because these function calls, properties, and callbacks exist, a programmer must understand them all in order to know whether they are required in an application. Therefore, as different call control protocols emerge, such as the International Telecommunication Union (ITU) H.323 protocol, the Session Initiation Protocol (SIP), and the Media Gateway Control Protocol (MGCP), there would be a tremendous advantage for a single client application to be able to place calls through multiple call control protocols. This advantage is even more pronounced when considering that certain protocols are preferable over others depending on the operations called for by the client application. It would be useful to be able to utilize different protocols based on specific situations as this would increase the flexibility of the client application.

### BRIEF DESCRIPTION OF THE DRAWINGS

FIG. 1 illustrates a plugable call control program interface communications system according to an embodiment of the present invention; and

FIG. 2 illustrates a flow chart diagram of the operation of a plugable call control program interface in a communications system according to an embodiment of the present invention.

### DETAILED DESCRIPTION

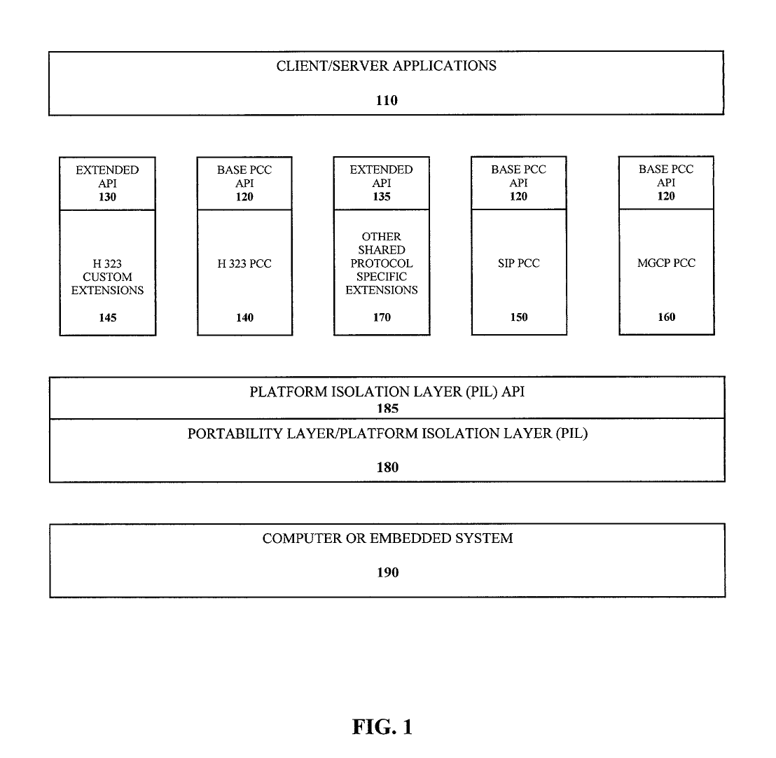

FIG. 1 illustrates a plugable call control program interface communications system according to an embodiment of the present invention. A client or server application 110 executes on a computer (or communications) system 190, such as a user workstation or a server system. The client or server application 110 may be a client endpoint/user phone or conferencing application, such as Intel Video Phone, Intel Internet Phone, or Microsoft NetMeeting. The client or server application 110 may also be a server application, such as a gatekeeper that provides telephone services from directory services, call routing services, security services, call logging services, etc. Other server applications 110 may include gateways that provide hopon/hop-off capability to convert between public switched telephone network (PSTN) and Internet Protocol (IP) telephony, proxies that convert between different IP telephony protocols, or proxies that may be used without any conversion along side a firewall. The client or server application 110 may be stored on, for example, a computer-readable medium, such as a hard disk, optical disk, semiconductor memory, magnetic tape, a hardware device having a software stack (particularly when the device and software are different mediums), or any other suitable computer-readable medium.

A base plugable call control (PCC) application program interface (API) 120 is provided to expose a common set of function calls, properties, and callbacks to be utilized by a plurality of call control protocols 140, 150, 160. In the example illustrated in FIG. 1, the base plugable call control API 120 exposes a common set of function calls, properties, and callbacks utilized by the H.323 protocol 140, the SIP protocol 150, and the MGCP protocol 160. It is preferable that the base plugable call control API 120 exposes the fewest possible number of parameters for each function call so as to provide the simplest usage model for the default call model. By utilizing a simple default call model and presenting only those function calls, properties, and callbacks that are required to make a basic call, a single client application may be written so that through a single base plugable call control API 120, calls may be made by utilizing any one of a number of call control protocols available so that the optimum call control protocol may be selected for any given situation.

In the example illustrated in FIG. 1, the base H.323 PCC protocol 140, the base SIP PCC protocol 150, and the base MGCP PCC protocol 160 are the base plugable call control protocol sets that allow a client application utilizing the base plugable call control API 120 to make simple calls utilizing, for example, any one of the H.323 protocol, the SIP protocol, and the MGCP protocol. Any number of base plugable call control protocols may be provided and supported by the base plugable call control API 120, particularly as new call control protocols and standards emerge. Some examples of common function calls, properties, and callbacks that may be exposed by the base plugable call control API 120 include: (1) listening for incoming calls, (2) placing calls, (3) answering calls, (4) hanging up calls, (5) capability selection, negotiation and renegotiation, (6) security (authentication, integrity), (7) call hold, (8) mute, (9) establishing multi-point conferences, merging multiple conferences into one, (10) splitting a conference into two, (11) transferring with and without consultation, (12) overlapped sending and dialing, (13) sending dual-tone modulation frequency (DTMF) signals, (14) multi-line/multi-call/multi-station appearance, (15) park/pickup calls, (16) redirect/forward calls, and (17) out-of-band service commands.

However, the software architecture according to an embodiment of the present invention also provides for access to advanced calling features via custom extensions 145 and 170. Because the base plugable call control API 120 is preferably configured so that default values or null substitutions are provided for all the advanced function calls, properties, and callbacks available in the plurality of supported call control protocols 140, 150, 160, base as well as custom extensions 140, 150, 160, 145, 170 may be provided to override these default values or null substitutions so that the advanced function calls, properties, and callbacks may be accessible to the client application 110. An extended application program interface (API) 130, 135 may be provided to expose protocol-specific advanced function calls, properties, and callbacks (with data provided therewith) of the supported call control protocols 140, 150, 160 that are obscured by the base plugable call control API 120. The extended API 130, 135 may be provided to expose any or all of the protocol-specific advanced function calls, properties, and callbacks. For example, an H.323 protocol extension module 145 may be provided to work with the base plugable call control API 120 and provide additional protocol-specific (H.323 protocol) capability, functionality, and information above the base plugable call control API 120.

For example, some additional features of the H.323 protocol extension module 145 may include a function to send ITU Q.931 protocol messages, which is an “advanced” feature not generally required to perform basic calling. The Q.931 protocol is a specific telephony protocol that is used by multiple umbrella protocols, such as the ITU H.320 and H.323 protocols. Additional property identifiers may also be provided by the H.323 protocol extension module 145, such as properties to set a caller/callee party number, or to identify whether to utilize “tunneling”. Tunneling is the process of sending ITU H.245 protocol data units (PDUs) through the Q.931 channel. The same Transmission Control Protocol/Internet Protocol (TCP/IP) socket that is already in use for the call signaling channel is also used by the H.245 control channel. Therefore, by making available the H.323 protocol extension module 145, client applications may be written to utilize these advanced features for those that require them, while still making a common set of function calls, properties, and callbacks available for all the supported call control protocols 140, 150, 160 for the client application via a single base plugable call control API 120.

Other shared protocol-specific extensions may also be provided in such an extension module 170 to make available additional functionality to the client application via the extended API 130, 135. An example of a shared protocol-specific extension that may be provided is an ITU H.245 protocol terminal capabilities (termcaps) API. The H.245 termcaps API may be provided to facilitate creation, parsing, and manipulation of H.245 terminal capabilities.

A portability layer, or platform isolation layer (PIL) 180, having a PIL application program interface (API) 185, may be provided with the base plugable call control API 120 and the extended API 130, 135. The platform isolation layer 180 is a reduced set of basic and system functionality that may be provided on top of arbitrary operating systems executing on the computer or embedded system 190. Accordingly, if the software stack components (most importantly, the client application 110) are written to depend only upon the provided PIL functionality for runtime library support, system services, etc., then the software stack can be easily “ported” to other operating systems once the platform isolation layer 180 (and PIL API 185) has been ported as well. Software that is easily ported is “portable”, meaning that the software has the ability to run on a variety of computer systems and/or operating systems. The terms “portable” and “machine-independent” have the same meaning, in that the software does not depend on a particular type of hardware. Therefore, if the plugable call control API 120 and the extended APIs 130, 135 have been written to use the platform isolation layer 180 rather than the compiler's runtime and operating system's functions, the plugable call control implementations are called portable. Additionally, if the client application 110 also uses the platform isolation layer 180 rather than the compiler's runtime and operation system's functions, it too is called portable. Consequently, simply implementing the platform isolation layer 180 on a given hardware platform will for all intents and purposes make the code written to use this platform isolation layer 180 portable to that given hardware platform. Although the platform isolation layer 180 is a separate component that is not required to implement the plugable call control application program interface according to an embodiment of the present invention, the platform isolation layer 180 adds to the portability feature of this software architecture. Of course, the platform isolation layer 180 is not restricted to just computer systems, but may be adapted to execute on any embedded system 180 to which the platform isolation layer 190 may be ported.

Moreover, if the base plugable call control API 120, the extended API 130, 135, and the platform isolation layer 180 and platform isolation layer API 185 are written in, for example, the American National Standards Institute (ANSI) “C” language (such as C or C++), it becomes more easily portable to other operating systems and/or computer systems as compared to, for example, Telephony Application Programming Interface (TAPI).

Another key distinguishing feature according to an embodiment of the present invention is the way, taking as an example the H.323 implementation, the base plugable call control implementation 140 any protocol specific extensions provided 145, 170 intertwine and yet remain separate. An H.323 call can be placed using only the base plugable call control API 120. The call could be placed another way which would cause H.245 to be tunneled over the Q.931 channel by simply using one of the H.323 extension's API 130 properties to enable tunneling. The new call would be placed in the same manner as the first call was placed, using the same base APIs, with the exception of the aforementioned property call to enable tunneling being inserted into the original call sequence in the appropriate place.

In addition to allowing modification to the default behavior of the call, the extended API 130, can also provide protocol specific information along with base defined callbacks. This is accomplished by the protocol specific implementation 140 actually defining a super structure for a given base structure, whose first member is the associated base structure. This will allow the implementation 140 to pass up a pointer to a structure which would be readable by applications 110, who only looked at the base callback structures as well as those who choose to access the protocol specific information which may follow after the end of the base structure. Take for example the incoming call callback for which the base API 120 may define a structure named PCC_CALL_INCOMING_PARAMS. The H.323 extension may define a structure named P323CC_CALL_INCOMING_PARAMS whose first member is PCC_CALL_INCOMING_PARAMS. When an incoming call indication is received by the stack, it can prepare a P323CC_CALL_INCOMING_PARAMS structure to accompany the base callback indication for incoming calls. The application 110 can determine by examining the base structure, that additional information is available, and in this example, can access the additional information by referencing the buffer of data supplied as a P323CC_CALL_INCOMING_PARAMS structure rather than simply a PCC_CALL_INCOMING_PARAMS structure. Finally, it should be noted that plugable call control extensions 170 need not be intertwined with specific protocol implementations 140, 150, 160. They may be designated to provide any special services or features, usually in the form of functions, properties, or callbacks, deemed useful and which are not provided by the base API 120.

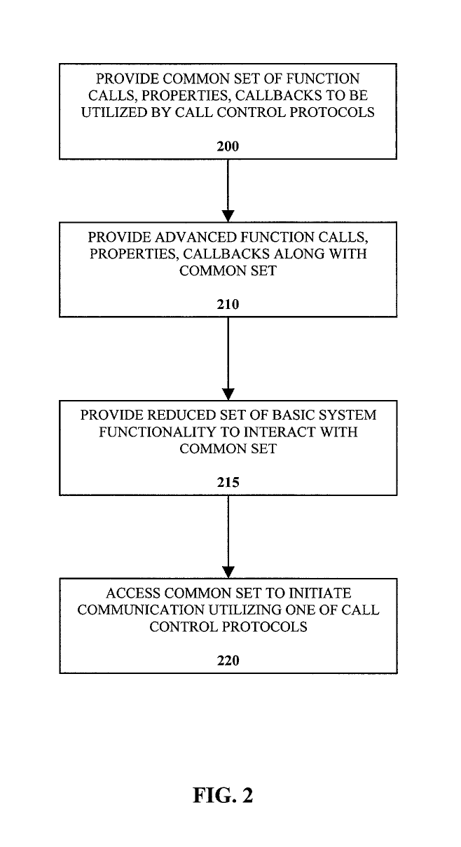

FIG. 2 illustrates a flow chart diagram of the operation of a plugable call control program interface in a communications system according to an embodiment of the present invention. First, a common set of function calls, properties, and callbacks is provided 200 to be utilized by the plurality of call control protocols 140, 150, 160. The common set of function calls, properties, and callbacks is preferably exposed by a base plugable call control API 120 for the supported call control protocols 140, 150, 160. Advanced function calls, properties, and callbacks are preferably provided 210 to allow access by the client application 110 to the advanced calling features of a particular call control protocol. These advanced features are preferably exposed to the client application 110 by an extended API 130, 135. Once the common set of function calls, properties, and callbacks have been provided 200, they may be accessed 220 by the client application 110 to initiate a communication utilizing one of the supported call control protocols 140, 150, 160. A reduced set of basic system functionality to interact with the common set of function calls, properties, and callbacks may also be provided 215, preferably, in the form of a platform isolation layer (PIL) 180 and a PIL API 185. Accordingly, the client application 110 may execute on the computer or embedded system 190 and initiate the communication to access the common set of function calls, properties, and callbacks exposed by the base plugable call control API 120.

By utilizing the software architecture according to an embodiment of the present invention, a programmer of a client or server application 110, capable of initiating communication using any one of a number of available call control protocols 140, 150, 160, need only to understand the function calls, properties, and callbacks for initiating basic call functions via a single base plugable call control API 120. Therefore, the client or server application 110 may be more easily written to support a plurality of call control protocols 140, 150, 160 (albeit with only the basic call functions available), as learning all of the function calls, properties, and callbacks for each supported call control protocol is a daunting task. But, most non-basic call functions of call control protocols are never utilized anyway, and therefore, a client or server application 110 utilizing a base plugable call control API 120 to access the basic calling function is usually more than adequate.

However, if the advanced features of a call control protocol are required, they may still be implemented via an extension module 145, 170, exposed by an extended API 130, 135. The client application 110 may be written to access the extended API 130, 135 in order to utilize the advanced functionality available in, for example, a supported call control protocol 140, 150, 160. Accordingly, the flexibility of a client application 110 is greatly increased by providing basic functionality for initiating calls via any one of a plurality of call control protocols, while still maintaining the ability to utilize advanced features of any one of the supported call control protocols, if required.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A plugable call control application program interface, comprising:
a base plugable call control application program interface to expose a common set of function calls, properties, and callbacks to be utilized by a plurality of call control protocols; and
an extended application program interface to provide at least one of advanced function calls, properties, and callbacks beyond the common set.

2. The plugable call control application program interface according to claim 1, further including:
a platform isolation layer having a reduced set of basic system functionality to interact with the base plugable call control application program interface and the extended application program interface; and
a software application executing on a communications system that accesses the base plugable call control application program interface to initiate a communication utilizing one of the plurality of call control protocols.

3. The plugable call control application program interface according to claim 2, wherein the communications system is a computer system.

4. The plugable call control application program interface according to claim 2, wherein the communications system is an embedded system.

5. The plugable call control application program interface according to claim 1, wherein the plurality of call control protocols include at least one of an International Telecommunication Union (ITU) H.323 protocol, a Session Initiation Protocol (SIP), and a Media Gateway Control Protocol (MGCP).

6. The plugable call control application program interface according to claim 1, wherein the call control protocols are Internet Protocol (IP) telephony call control protocols.

7. The plugable call control application program interface according to claim 1, wherein the plugable call control application program interface is an American National Standards Institute (ANSI) “C” application program interface.

8. The plugable call control application program interface according to claim 1, wherein the at least one of advanced function calls, properties, and callbacks provide additional protocol-specific functionality to at least one of the plurality of call control protocols.

9. The plugable call control application program interface according to claim 1, wherein the at least one advanced function calls, properties, and callbacks beyond the common set is accessed using the base plugable call control application program interface.

10. The plugable call control application program interface according to claim 1, wherein the extended application program interface provides protocol specific information along with base defined callbacks.

11. A method of performing call control on a communications system, the method comprising:
providing a common set of function calls, properties, and callbacks to be utilized by a plurality of call control protocols;
providing at least one of advanced function calls, properties, and callbacks beyond the common set; and
accessing the common set of function calls, properties, and callbacks to initiate a communication utilizing one of the plurality of call control protocols.

12. The method according to claim 11, further including:
providing a reduced set of basic system functionality to interact with the common set of function calls, properties, and callbacks; and
executing a software application on a communications system to access the common set of function calls, properties, and callbacks to initiate the communication utilizing one of the plurality of call control protocols.

13. The method according to claim 12, wherein the communications system is a computer system.

14. The method according to claim 12, wherein the communications system is an embedded system.

15. The method according to claim 11, wherein the plurality of call control protocols include at least one of an International Telecommunication Union (ITU) H.323 protocol, a Session Initiation Protocol (SIP), and a Media Gateway Control Protocol (MGCP).

16. The method according to claim 11, wherein the call control protocols are Internet Protocol (IP) telephony call control protocols.

17. The method according to claim 11, further including providing with the at least one of advanced function calls, properties, and callbacks additional protocol-specific functionality to at least one of the plurality of call control protocol.

18. The method according to claim 11, wherein the at least one advanced function calls, properties, and callbacks beyond the common set is accessed using the base plugable call control application program interface.

19. The method according to claim 11, wherein the extended application program interface provides protocol specific information along with base defined callbacks.

20. A communications system, comprising:
a computer-readable medium; and
computer-readable program code, stored on the computer-readable medium, adapted to be loaded and executed on an operating system of the communications system, the computer-readable program code performing,
providing a common set of function calls, properties, and callbacks to be utilized by a plurality of call control protocols,
providing at least one of advanced function calls, properties, and callbacks beyond the common set, and
accessing the common set of function calls, properties, and callbacks to initiate a communication utilizing one of the plurality of call control protocols.

21. The communications system according to claim 20, wherein the computer-readable program code further performs:
providing a reduced set of basic system functionality to interact with the common set of function calls, properties, and callbacks; and
executing a software application on the communications system to access the common set of function calls, properties, and callbacks to initiate the communication utilizing one of the plurality of call control protocols.

22. The communications system according to claim 20, wherein the plurality of call control protocols include at least one of an International Telecommunication Union (ITU) H.323 protocol, a Session Initiation Protocol (SIP), and a Media Gateway Control Protocol (MGCP).

23. The communications system according to claim 20, wherein the call control protocols are Internet Protocol (IP) telephony call control protocols.

24. The communications system according to claim 20, wherein the computer-readable program code further performs providing with the at least one of advanced function calls, properties, and callbacks additional protocol-specific functionality to at least one of the plurality of call control protocols.

25. The communications system according to claim 20, wherein the communications system is a computer system.

26. The communications system according to claim 20, wherein the communications system is an embedded system.

27. The communications system according to claim 20, wherein the at least one advanced function calls, properties, and callbacks beyond the common set is accessed using the base plugable call control application program interface.

28. The communications system according to claim 20, wherein the extended application program interface provides protocol specific information along with base defined callbacks.
